(19) United States
(12) Patent Application Publication
(10) Pub. No.: US 2007/0081147 A1
(43) Pub. Date: Apr. 12, 2007

(54) METHOD FOR DYNAMIC MEASURING THE POSITION AND THE ORIENTATION OF A WHEEL

(75) Inventor: Alex Van Den Bossch, Leuven (BE)

Correspondence Address: BROWDY AND NEIMARK, P.L.L.C.;624 NINTH STREET, NW, SUITE 300, WASHINGTON, DC, 20001-5303, US

(73) Assignee: N.V. Krytpon Electronic Engineering

(21) Appl. No.: 11/559,223

(22) Filed: Nov. 13, 2006

Related U.S. Application Data
(63) Continuation of application No. 10/503,466, filed on Aug. 4, 2004, now abandoned.

(30) Foreign Application Priority Data
Feb. 5, 2002 (BE) 2002/0069

(51) Int. Cl. G01C 1/00

(52) U.S. Cl. 356/139.09

(57) ABSTRACT

The invention concerns a device and a method for measuring the position and/or orientation of a first element (3) with respect to a second element (2) of a vehicle, on which this first element (3) is mounted in a movable manner, with the aid of an optical measuring system with at least one camera unit (1), whereby at least three references (4,5,6), not laying on a strait line, are provided on one of these elements (3) such that these references (4,5,6) can be perceived by the camera unit (1). Said camera unit (1) is mounted fixed with respect to the other element (4) and the position of said references (4,5,6) is measured with said optical measuring system for successive positions and/or orientations of the element (3) on which these references (4,5,6) are provided.

The invention concerns a method for measuring the position and/or the orientation of a first part in relation to a second part of a vehicle upon which said first part is mounted in a moveable manner, by means of an optical measuring system with at least one camera unit, whereby at least three references which are not situated on a straight line are provided on one of said parts, such that these references can be perceived by the camera unit. Said vehicle is for example a passenger car, a lorry, a motorbike, etc., while said parts may for example consist of a wheel and the coachwork of the vehicle.

According to the present state of the art, measurements are carried out to determine the position of the wheel of a vehicle in relation to its coachwork. The wheel is hereby connected to the coachwork via a mechanical measuring arm comprising a number of sensors. With such a system it is not possible to perform measurements while the wheel is moving at high frequencies, due to the inertia of the measuring arm. Measurements at very low frequencies cannot be performed with sufficient accuracy either. As a consequence, the range of such measurements is very restricted. Moreover, the behaviour of the coachwork and the wheel will be influenced by the measuring arm mounted upon it.

Several optical measuring systems are known to measure the position of the wheel of a vehicle or to determine the deformation of its coachwork on a test bench. Such measuring systems comprise a relatively large number of camera units, and they cannot be applied to a vehicle moving on a test circuit, for example.

The invention aims to remedy these disadvantages by providing a method to measure the position and orientation of a wheel in relation to the coachwork of a vehicle while this vehicle is moving. Thus, it will be possible to perform position measurements of the wheel in what is called a real road situation without this having practically any effect whatsoever on the behaviour of the vehicle. Moreover, the method according to the invention also allows to measure the position of the wheel in a very precise manner while it is being subjected to movements at very high or very low frequencies, even for large wheel movements.

To this aim, said camera unit is mounted fixed in relation to the other part, and the position of said references is measured with said optical measuring system for successive positions and/or orientations of the part upon which these references are provided.

Practically, the three-dimensional position of the part upon which said references are provided is determined by performing a two-dimensional position measurement for each of said references for a specific position of said part, whereby the position of the references, and thus of the part upon which said references are provided, is determined in a three-dimensional way on the basis of the real distance between the references and the measured two-dimensional position.

In an advantageous manner, a matrix camera is used for said camera unit.

In a particularly advantageous manner, said camera unit is composed by setting up two linear cameras in two different directions, preferably in one and the same plane. The linear cameras are preferably set up at right angles to one another.

The invention also concerns a method to determine the spatial position of an object by means of an optical measuring system comprising a camera unit, whereby at least three references are provided on this object which can be perceived by said camera unit. This method is characterised in that, with said camera unit, the position of said references is first measured in two dimensions, after which, on the basis of the real distance between said reference points, the spatial position of said references is calculated.

Other particularities and advantages of the invention will become clear from the following description of an embodiment of the method according to the invention; this description is given as an example only and does not restrict the scope of the claimed protection in any way; the figures of reference used hereafter refer to the accompanying drawings.

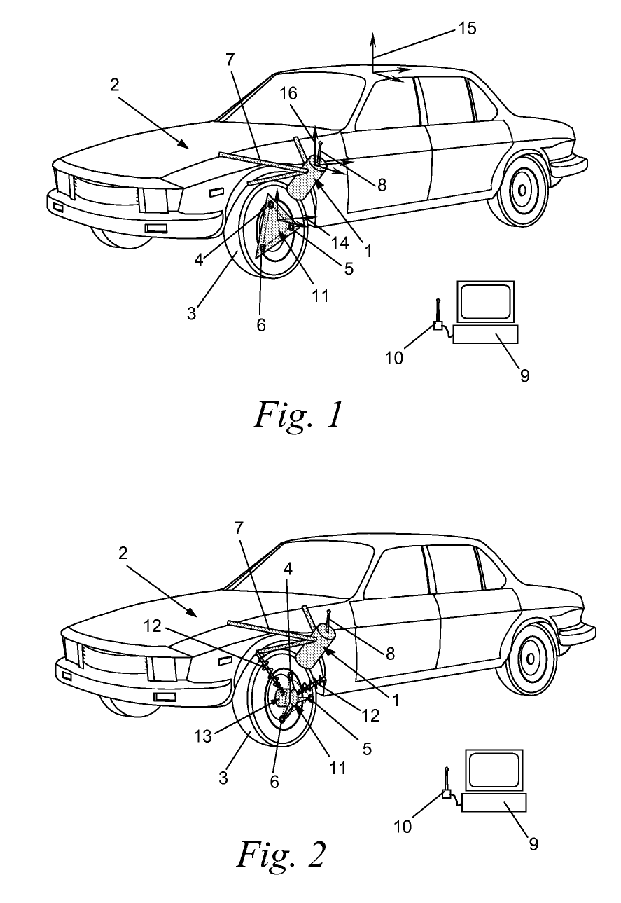

FIG. 1 is a schematic view in perspective of a wheel and the coachwork of a vehicle upon which is placed a camera unit of an optical measuring system according to a first embodiment of the invention.

FIG. 2 is a schematic view in perspective of a wheel and the coachwork of a vehicle upon which is placed a camera unit of an optical measuring system according to a second embodiment of the invention.

In the different drawings, the same reference figures refer to identical or analogous elements.

In this description, the concept position implies the spatial location of an object as well as its orientation. Since an object has six degrees of freedom in a three-dimensional space, i.e. three translational and three rotational degrees of freedom, the position of this object is determined as soon as six degrees of freedom are defined. The position of a point, which is represented for example by the references described hereafter, is determined by defining its three translational degrees of freedom.

The invention concerns a method for measuring the position of a first part in relation to the second part of a vehicle. According to a preferred embodiment of the method according to the invention, these parts consist of a wheel and the coachwork of a vehicle respectively, and the position and/or orientation of this wheel is measured in relation to the coachwork upon which it is mounted. According to this method, a camera unit 1 of an optical measuring system is fixed on the coachwork 2 by means of a support 7, as is schematically represented in FIG. 1. The camera unit 1 comprises a transmitter and a receiver which are connected to a processing unit 9 via an antenna 8, which also works in conjunction with a transmitter and receiver 10. In this manner it is possible to send signals from the camera unit 1 to the processing unit 9 and to control the camera unit 1 by means of the latter.

Further, at least three references 4, 5 and 6 are provided on the wheel 3. These references 4, 5 and 6 consist for example of a light-emitting diode (LED) and they can be perceived by said camera unit 1. When the spatial position of the references 4, 5 and 6 is thus measured by means of the optical measuring system in a manner known as such, also the spatial position of the wheel 3 will be known. Indeed, the position of these three reference points 4, 5 and 6, which are fixed to the wheel 3, univocally determines the spatial position of the latter.

In order to make calculations in a simple manner, a wheel co-ordinate system 14 is selected which is fixed to the wheel 3. The references 4, 5 and 6 are thus defined by their position in this wheel co-ordinate system 14.

According to a preferred embodiment of the method according to the invention, a basic co-ordinate system is associated with the camera unit 1 of the coachwork 2. In particular, a vehicle co-ordinate system 15 is selected which is fixed to the vehicle, and a camera co-ordinate system 16 which is fixed in relation to the camera unit 1. Thus, the co-ordinates of the measured position of the references 4, 5 and 6 are preferably calculated in relation to the vehicle co-ordinate system 15 by the optical measuring system.

A first measurement is for example performed while the vehicle is standing still and the wheel 3 is in a rest position. The position of the references 4, 5 and 6 in this rest position thus determines a reference position. Next, the position of the references 4, 5 and 6 is measured while the vehicle is moving, and these measured positions are compared to said reference position. Consequently, the relative movement and the corresponding position of the wheel 3 in relation to the coachwork 2 is determined in this manner.

Thus, it becomes possible, for example, to study the behaviour of a vehicle while it is moving and riding on a test road, for example. This allows in particular to study the suspension and springs of a wheel 3 in relation to the coachwork 2, as well as the road stability of the vehicle.

According to a special embodiment of the method according to the invention, the positions of said references 4, 5 and 6 are measured in two dimensions by means of the camera unit 1. In particular, for a specific position of the wheel 3, the co-ordinates of the position of each of the references 4, 5 and 6 are determined according to two preferably perpendicular directions in a plane standing at right angles to the optical axis of the camera unit 1.

Next, the actual three-dimensional position of the references 4, 5 and 6 is calculated on the basis of the positions of the references 4, 5 and 6, thus measured in a two-dimensional manner, and the real distance between each of these references 4, 5 and 6.

In the case of a two-dimensional position measurement, one measures the position of said references 4, 5 and 6 in a plane standing at right angles to the optical axis of the camera unit 1. By taking into account, however, that these references 4, 5 and 6 have a fixed position in relation to one another, the co-ordinate of each of the references 4, 5 and 6 is calculated on the basis of the real spatial distances between these references 4, 5 and 6 and their co-ordinates measured in a two-dimensional manner, according to the direction of the optical axis of the camera unit 1. This calculation is made according to conventional goniometric calculation methods. Subsequently, the co-ordinates of the references 4, 5 and 6 may possibly be expressed in three dimensions in relation to the above-mentioned basic co-ordinate system in order to compare the thus determined position of the references 4, 5 and 6 with the aforesaid rest position, for example.

In an advantageous manner, the camera unit 1 comprises two of what are called linear cameras. Such a linear camera comprises a straight row of successive sensors with which can be perceived an image, such that a position can be measured with it in a single dimension.

Thus, the camera unit 1 comprises two linear cameras which are set up in the same plane, but in two different directions. This implies that said rows of sensors of the cameras extend in one and the same plane according to two intersecting straight lines. In order to simplify the calculations, these linear cameras are preferably set up at right angles, such that said rows of sensors stand at right angles in relation to one another in one and the same plane. The optical axis of the camera unit 1 will then extend perpendicular to said plane.

By means of such a camera unit 1 having two linear cameras, the position of said references 4, 5, and 6 is measured in two dimensions. The position of the references is hereby measured with each of the linear cameras according to the direction of the corresponding row of sensors.

Then, as described above, on the basis of said two-dimensional measurement and the actual distance between the reference points 4, 5 and 6, the co-ordinates of the references 4, 5 and 6 in said basic co-ordinate system are calculated.

Naturally, said camera unit 1 may also comprise a matrix camera, for example. This matrix camera makes it possible to perform said two-dimensional position measurement. The optical axis hereby extends almost perpendicular to the observation plane of the matrix camera.

According to a very interesting embodiment of the method according to the invention, said references 4, 5 and 6 are mounted fixed on a support 11. In this manner is made sure that the distance between the references 4, 5 and 6 is almost constant. The support 11, which is represented in FIG. 1, is formed of a flat, triangular plate and is preferably mounted on the wheel 3 in a detachable manner.

As the references 4, 5 and 6 are fixed on a support, the actual distance between these references can be measured in a simple manner.

The method according to the invention also makes it possible to determine the position of the axis of rotation of the wheel 3 in relation to the references 4, 5 and 6, or in relation to the above-mentioned basic co-ordinate system, by rotating the wheel 3 in at least three different positions around its axis of rotation.

During this rotational movement, the successive positions of at least one reference 4, 5 or 6 is measured. These measured positions are situated on an arc. The centre of the circle upon which the arc is situated, as well as the plane comprised in this arc, are calculated in order to determine the exact position of the point of rotation and the axis of rotation. Thus, the point of rotation of the wheel 3 coincides with this centre, and its axis of rotation coincides with the perpendicular bisector of this circle, which is the straight line going through the point of rotation and standing at right angles to the plane of the circle.

In order to detect whether the camera unit 1 occupies a fixed position in relation to the coachwork 2, an additional reference is fixed on the coachwork 2, near the wheel 3, in an advantageous manner. This additional reference is defined by its co-ordinates in said vehicle co-ordinate system 15, and it is also observed by the camera unit 1. When the spatial position of the references 4, 5 and 6 fixed on the wheel 3 is measured, also the two-dimensional position of this additional reference will be measured. When it is thus observed that the position of this reference has changed within said camera co-ordinate system 16, the movement of the camera unit 1 in relation to the coachwork 2 will be determined on the basis thereof. This makes it possible to correct the measured positions of the wheel 3 on the basis of the detected movement of the camera unit 1, or to take this into account for the interpretation of the position measurements.

In order to take into account a possible movement of the camera unit 1 in relation to the coachwork 2 in a more precise manner, it is possible to provide for example three reference points on the coachwork 2 near the wheel 3. The exact distance between these references is hereby determined, and the spatial position of the coachwork 2 in relation to the camera unit 1 can be determined in the same manner as described above.

Further, a camera unit 1 can be fixed in front of more than one wheel 3 of the vehicle. Thus, it becomes possible to apply the method according to the invention simultaneously to each of the three wheels 3 of the vehicle, for example, and to measure the positions of the different wheels in relation to one another. The latter makes it possible, for example, to study the dynamic behaviour of the wheels 3 in relation to one another.

In order to determine the mutual positions of the different camera units in this case, fixed references are provided on the coachwork which can be perceived by at least two camera units 1.

In a very advantageous manner, said support 11 is mounted on the wheel 3 via an angle encoder 13 at the height of its point of rotation, whereas the support 11 itself is fixed to the coachwork 2 of the vehicle, as is schematically represented in FIG. 2. The support 11 is preferably connected to the coachwork 2 in an elastic manner by means of for example mechanical springs 12. Thus, the references 4, 5 and 6 provided on the support 11 will not rotate together with the wheel 3 around the wheel shaft while the vehicle is in motion.

The use of such an angle encoder 13 makes it possible, for example, to measure only the movement and the orientation of the wheel 3 in relation to the coachwork 2, whereby the rotation of the wheel 3 around its shaft cannot be perceived by means of the camera unit 1. By means of the angle encoder 13 is determined for example the speed of revolution of the wheel 3, so that this can be taken into account for the interpretation of the measured position and/or orientation of the wheel 3.

In a simple variant of this embodiment, the support 11 is mounted on the wheel 3 in such a manner that it can freely rotate around its wheel shaft. The support 11 is then connected to the coachwork 1 by means of one or several springs 12, such that this support 11 cannot practically undergo any rotation around the shaft of the wheel 3.

It is clear that the method and the device according to the invention are not restricted to measuring the position and/or orientation of the wheel of a vehicle in relation to its coachwork. Thus, the invention can be applied to determine the position or the movement of any object whatsoever in relation to the coachwork of a vehicle.

Thus, said references 4, 5 and 6 are fixed for example to a dummy placed in the vehicle, preferably to the head of such a dummy, during what is called a crash test, or also to the engine block of a vehicle.

Further, it is possible to measure certain deformations of the coachwork 2 by means of the method and the device according to the invention. In particular, it is possible to determine torsions of the coachwork 2 by applying said references 4, 5 and 6 on the coachwork itself and by subsequently determining the change in position and/or orientation of the plane in which these references are situated when a load is applied to the coachwork.

Naturally, the invention is not restricted to the above-described method and the device represented in the accompanying figure.

Thus, more than three references can be applied on the wheel. Possibly, a fourth reference can be selected which is not situated in the plane of the first three references.

Additional references can also be provided on the tyre around the wheel to thus measure for example the deformation or compression of the tyre. Further, it is not necessary, of course, for the processing unit 9 to work in conjunction with the camera unit 1 via a transmitter and receiver. The processing unit 9 may for example be placed in the vehicle itself and it can be connected directly to the camera unit 1.

The camera unit 1 may possibly comprise more than two linear cameras. Thus, the position of said references can be determined with greater accuracy thanks to the redundancy occurring during the measurement and the calculation of their position.

Neither is the shape of the support 11 restricted to a flat plate as described above. The support 11 may for example consist of a pyramidal, cylindrical or conical body upon which said references are provided. Further, more than three references can be fixed to the support, and said real distance between the references may for example be the distance according to an arc extending according to the surface of the support.

1. Method for measuring the position and/or the orientation of a first part (3) in relation to a second part (2) of a vehicle upon which said first part (3) is mounted in a moveable manner, by means of an optical measuring system with at least one camera unit (1), whereby at least three references (4,5,6) which are not situated on a straight line are provided on one of said parts (3), such that these references (4,5,6) can be perceived by the camera unit (1), characterised in that said camera unit (1) is mounted fixed in relation to the other part (4) and in that the position of said references (4,5,6) is measured by means of said optical measuring system for successive positions and/or orientations of the part (3) upon which these references (4,5,6) are provided.

2. Method according to claim 1, characterised in that the three-dimensional position of the part (3) upon which said references (4,5,6) are provided is determined by performing a two-dimensional position measurement for each of said references (4,5,6) for a specific position of said part (3), whereby the position of the references (4,5,6), and thus of the part (3) upon which said references (4,5,6) are provided, is determined in a three-dimensional way on the basis of the real distance between the references (4,5,6) and the measured two-dimensional position.

3. Method according to claim 1 or 2, characterised in that a matrix camera is used for said camera unit (1).

4. Method according to any of claims 1 to 3, characterised in that said camera unit (1) is composed by setting up two linear cameras in two different directions in one and the same plane.

5. Method according to claim 4, characterised in that said linear cameras are said up at right angles in relation to one another.

6. Method according to any of claims 1 to 5, characterised in that said references (4,5,6) are mounted fixed on a support (11), whereby this support (11) is fixed on the part (3) upon which said references (4,5,6) are provided.

7. Method according to claim 6, characterised in that said support (11) is mounted in a rotating manner on a wheel (3) of the vehicle, such that when this wheel (3) rotates around its wheel shaft, the position and orientation of the references (4,5,6) in relation to the coachwork (2) of the vehicle will remain practically unaltered.

8. Method according to any of claims 1 to 7, characterised in that at least one additional reference is provided on the part (2) upon which said camera unit (1) is mounted within the field of vision of this camera unit (1), whereby the position of this additional reference is measured in order to detect a possible movement of the camera unit (1) in relation to this part (2) and to possibly compensate for it.

9. Method according to any of claims 1 to 8, characterised in that the position and/or orientation of said parts (2,3) in relation to one another is measured while said vehicle is in motion.

10. Method according to any of claims 1 to 9, characterised in that said references (4,5,6) are provided on at least a wheel (3) of the vehicle.

11. Method according to any of claims 1 to 10, characterised in that said camera unit (1) is mounted fixed in relation to the coachwork (2) of the vehicle.

12. Method according to any of claims 1 to 9, characterised in that said references (4,5,6) are provided on the coachwork (2) of said vehicle, whereby said camera unit (1) is mounted in a rotating manner on a wheel (3) of the vehicle, such that, when this wheel (3) rotates around its wheel shaft, the position and orientation of the camera unit (1) in relation to the coachwork remain practically unaltered.

13. Method to determine the spatial position of an object (2,3) by means of an optical measuring system comprising a camera unit (1), whereby at least three references (4,5,6) are provided on this object (2,3) which can be perceived by said camera unit (1), characterised in that the position of said references (4,5,6) is measured in two dimensions with said camera unit (1), whereby the spatial position of said references (4,5,6) is subsequently calculated on the basis of the real distance between said references (4,5,6).

14. Method according to claim 13, characterised in that a matrix camera is used for said camera unit (1).

15. Method according to claim 14, characterised in that at least two linear cameras, set up in a non-parallel manner, are used as a camera unit (1).

16. Optical measuring system for measuring the relative position of a wheel (3) in relation to the coachwork (2) of a vehicle, whereby a camera unit (1) and at least three references (4,5,6) must be placed on said wheel (3), characterised in that said camera unit (1) comprises fixing means which make it possible to fix the camera unit (1) on said coachwork (2).

17. Optical measuring system according to claim 16, characterised in that said references (4,5,6) are mounted on a support (11), such that these references (4,5,6) occupy a fixed position in relation to one another, whereby this support (11) must be fixed on said wheel (3).

18. Optical measuring system according to claim 16 or 17, characterised in that said camera unit (1) comprises at least two linear cameras set up in different directions in relation to one other.

19. Optical measuring system according to claim 18, characterised in that said linear cameras are set up diagonally in relation to one another.
